(19) United States
(12) Patent Application Publication
(10) Pub. No.: US 2014/0244404 A1
(43) Pub. Date: Aug. 28, 2014

(54) AUTOMATED NEGOTIATION SYSTEM AND METHOD

(71) Applicant: Paycollective Inc., Brooklyn, NY (US)

(72) Inventors: Joshua Manson, New York, NY (US); Constantine Nicolaidis, New York, NY (US); Michael Carnevale, New York, NY (US)

(73) Assignee: Paycollective Inc., Brooklyn, NY (US)

(21) Appl. No.: 13/778,605

(22) Filed: Feb. 27, 2013

(51) Int. Cl. G06Q 30/06

(52) U.S. Cl. CPC G06Q 30/0611
USPC 705/14.72; 705/26.4

(57) ABSTRACT

A method of automated negotiation is provided. The method is implemented using at least one computer, and includes receiving, from a seller, an ask price for an item and a accept price for the item. The method also includes storing the ask price for the item and the accept price for the item in a memory element provided by the at least one computer. The method also includes providing the ask price for the item to a buyer and receiving, from the buyer, an offer price and a max price. The method also includes storing the offer price for the item and the max price for the item in the memory element. The method also includes calculating a final transaction price using the at least one computer and assessing a penalty to the buyer based at least on the offer price.

### FIELD OF THE INVENTION

The present invention relates generally to the field of automated negotiation, and more particularly to automated negotiation of a price of an item for sale.

### BACKGROUND OF THE INVENTION

Buying and selling items in a public marketplace traditionally has involved haggling, or negotiation of the price. Negotiation may be time-consuming, tiring, and stressful, and many buyers and sellers do not like having to haggle. Some businesses have instituted “no-haggle” or “non-negotiable” prices to eliminate this aspect of the business. Such a solution does not work if a buyer is unwilling to pay the “no-haggle” price, but is willing to pay a lower price that the business might prefer to accept in exchange for winning the buyer's business. Such solutions also are of limited value for transactions involving occasional, non-merchant sellers who may not have the clout or sophistication to institute a “no-haggle price.” Indeed, many non-merchant sellers may offer an item for sale, intending either explicitly or implicitly to avoid a time-consuming negotiation, but nevertheless may receive counteroffers and attempts to begin a negotiation from prospective buyers. Similarly, a buyer entering such a marketplace cannot hope to get the best possible price without negotiation if the marketplace operates on an assumption that all prices are negotiable. It would be advantageous both to buyers and sellers to be able to complete a transaction without the need to negotiate the price while performing the transaction at an appropriate price.

Attempts to replace direct, face-to-face negotiations or negotiations via correspondence such as by telephone, email, fax, etc. with quick computer-automated negotiations may be subject to parties attempting to “game the system,” as the parties to the negotiation may not always have sufficient incentives to provide realistic inputs to the computer-automated negotiation.

### SUMMARY OF THE INVENTION

In a first embodiment there is provided a method of automated negotiation, implemented using at least one computer. The method includes receiving an ask price for an item and a accept price for the item from a seller and storing the ask price for the item and the accept price for the item in a memory element provided by the at least one computer. The method further includes providing the ask price for the item to a buyer, receiving an offer price and a max price from the buyer, and storing the offer price for the item and the max price for the item in the memory element. The method further includes calculating a final transaction price using the at least one computer and assessing a penalty to the buyer based at least on the offer price.

In a related embodiment, the final transaction price is a midpoint between the max price and the accept price and assessing the penalty to the buyer includes 1) determining that the offer price is less than a first predetermined percentage of the accept price, and 2) increasing the final transaction price by a second predetermined percentage.

In a further related embodiment, the method also includes generating an advertisement of the item. The advertisement includes the ask price for the item.

In a further related embodiment, the method also includes generating a link to the advertisement.

In a further related embodiment, the method also includes providing the link to the seller.

In a further related embodiment, the method also includes displaying, to the seller, a first user interface comprising a first calendar, receiving, from the seller, via the user interface, a first input indicating at least one first time corresponding to the first calendar, displaying, to the buyer, a second user interface comprising a second calendar, the second calendar including information corresponding to the at least one first time, receiving, from the buyer, via the user interface, a second input indicating at least one second time corresponding to the second calendar, the at least one second time corresponding to at least one of the at least one first time, and determining, using the first input and the second input, a third time at which the item is to be delivered.

In a second embodiment there is provided an automated negotiation system. The system includes means for receiving an ask price for an item and a accept price for the item from a seller and means for storing the ask price for the item and the accept price for the item in a memory element provided by the at least one computer. The system further includes means for providing the ask price for the item to a buyer, means for receiving an offer price and a max price from the buyer, and means for storing the offer price for the item and the max price for the item in the memory element. The system further includes means for calculating a final transaction price using the at least one computer and means for assessing a penalty to the buyer based at least on the offer price.

In a related embodiment the final transaction price is a midpoint between the max price and the accept price and assessing the penalty to the buyer includes 1) determining that the offer price is less than a first predetermined percentage of the accept price, and 2) increasing the final transaction price by a second predetermined percentage.

In a further related embodiment, the system also includes means for generating an advertisement of the item. The advertisement includes the ask price for the item.

In a further related embodiment, the system also includes means for generating a link to the advertisement.

In a further related embodiment, the system also includes means for providing the link to the seller.

In a further related embodiment, the system also includes means for displaying, to the seller, a first user interface comprising a first calendar, means for receiving, from the seller, via the user interface, a first input indicating at least one first time corresponding to the first calendar, means for displaying, to the buyer, a second user interface comprising a second calendar, the second calendar including information corresponding to the at least one first time, means for receiving, from the buyer, via the user interface, a second input indicating at least one second time corresponding to the second calendar, the at least one second time corresponding to at least one of the at least one first time, and means for determining, using the first input and the second input, a third time at which the item is to be delivered.

In a third embodiment there is provided at least one computer-readable medium encoded with instructions that, when executed on at least one processing unit, perform a method of automated negotiation. The method includes receiving an ask price for an item and a accept price for the item from a seller and storing the ask price for the item and the accept price for the item in a memory element provided by the at least one computer. The method also includes providing the ask price for the item to a buyer, receiving an offer price and a max price from the buyer, and storing the offer price for the item and the max price for the item in the memory element. The method also includes calculating a final transaction price using the at least one computer. The method also includes assessing a penalty to the buyer based at least on the offer price.

In a related embodiment, the final transaction price is a midpoint between the max price and the accept price and assessing the penalty to the buyer includes 1) determining that the offer price is less than a first predetermined percentage of the accept price, and 2) increasing the final transaction price by a second predetermined percentage.

In a further related embodiment, the method further includes generating an advertisement of the item. The advertisement includes the ask price for the item.

In a further related embodiment, the method further includes generating a link to the advertisement.

In a further related embodiment, the method further includes providing the link to the seller.

In a further related embodiment, the method also includes displaying, to the seller, a first user interface comprising a first calendar, receiving, from the seller, via the user interface, a first input indicating at least one first time corresponding to the first calendar, displaying, to the buyer, a second user interface comprising a second calendar, the second calendar including information corresponding to the at least one first time, receiving, from the buyer, via the user interface, a second input indicating at least one second time corresponding to the second calendar, the at least one second time corresponding to at least one of the at least one first time, and determining, using the first input and the second input, a third time at which the item is to be delivered.

### BRIEF DESCRIPTION OF THE DRAWINGS

FIG. 1A is a system diagram illustrating a network connecting devices associated with embodiments of the present invention.

FIG. 1B is a system diagram illustrating a hardware architecture associate with embodiments of the present invention.

FIG. 2 is a flowchart illustrating a process of automated negotiation in accordance with an embodiment of the present invention.

FIG. 3 is a screenshot of a data entry screen allowing a seller to enter a description of an item for sale.

FIG. 4 is a screenshot of a data entry screen allowing a seller to submit an offer to sell in accordance with an embodiment of the present invention.

FIG. 5 is a screenshot of a preview of an advertisement.

FIG. 6 is a screenshot of a confirmation that an advertisement has been listed.

FIG. 7 is a screenshot of an advertisement in accordance with an embodiment of the present invention.

FIG. 8 is a screenshot of a data entry screen allowing a buyer to submit an offer to buy in response to the advertisement of FIG. 3.

FIG. 9 is a screenshot illustrating an offer that was submitted via the data entry screen of FIG. 4.

FIG. 10 is a screenshot of a message indicating that a sale price has been established in response to the offer of FIG. 5.

FIG. 11 is a screenshot of a data entry screen allowing a buyer to provide feedback about a seller.

FIG. 12 is a screenshot of a data entry screen allowing a seller to provide information for use in scheduling pick up of an item.

FIG. 13 is a screenshot of a listing of items that have been posted for sale.

FIGS. 14 and 15 are screenshots of data entry screens allowing a seller to provide images for use in advertisements.

FIG. 16 is a screenshot of a listing of items that have been purchased.

FIG. 17 is a screenshot of a data entry screen allowing a buyer to select an item on which to bid.

FIG. 18 is a screenshot illustrating information that is provided to a seller posting an item for sale.

FIGS. 19 and 20 are screenshots of data entry screens allowing a seller to provide information for use in arranging for delivery of an item.

### DETAILED DESCRIPTION OF ILLUSTRATIVE EMBODIMENTS

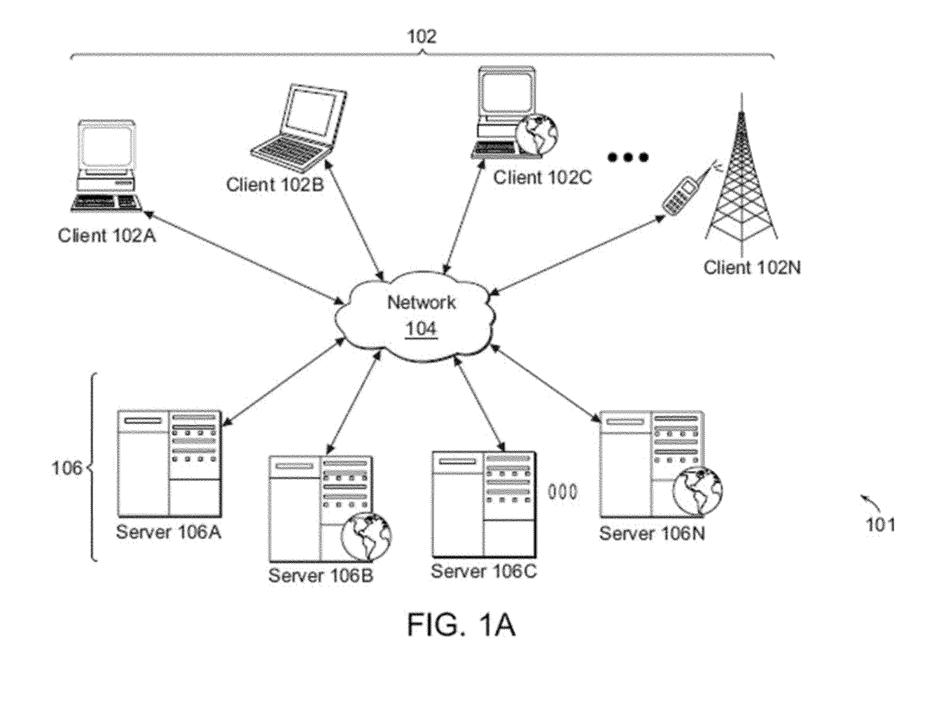

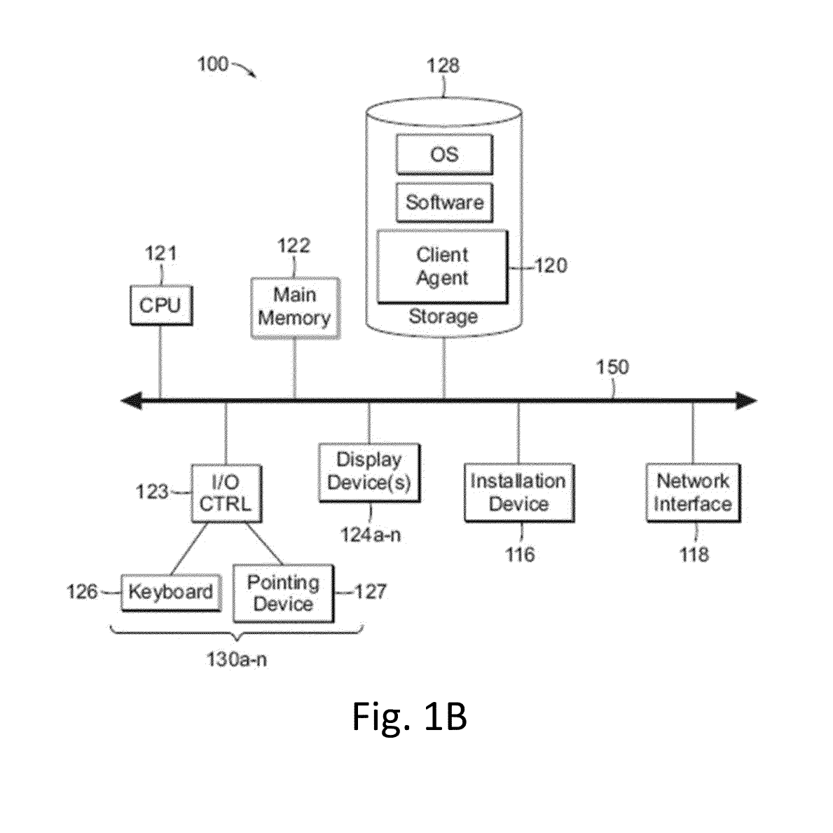

FIG. 1A illustrates one embodiment of a networked environment 101 in which an automated negotiation system can be provided. As shown in FIG. 1A, the networked environment 101 includes one or more client machines 102A-102N (generally referred to herein as “client machine(s) 102” or “client(s) 102”) in communication with one or more servers 106A-106N (generally referred to herein as “server machine(s) 106” or “server(s) 106”) over a network 104. The client machine(s) 102 can, in some embodiments, be referred to as a single client machine 102 or a single group of client machines 102, while server(s) 106 may be referred to as a single server 106 or a single group of servers 106. Although four client machines 102 and four server machines 106 are depicted in FIG. 1A, any number of clients 102 may be in communication with any number of servers 106. In one embodiment a single client machine 102 communicates with more than one server 106, while in another embodiment a single server 106 communicates with more than one client machine 102. In yet another embodiment, a single client machine 102 communicates with a single server 106. Further, although a single network 104 is shown connecting client machines 102 to server machines 106, it should be understood that multiple, separate networks may connect a subset of client machines 102 to a subset of server machines 106.

In one embodiment, the computing environment 101 can include an appliance (not shown in FIG. 1A) installed between the server(s) 106 and client machine(s) 102. This appliance can mange client/server connections, and in some cases can load balance connections made by client machines 102 to server machines 106. Suitable appliances are manufactured by any one of the following companies: the Citrix Systems Inc. Application Networking Group; Silver Peak Systems, Inc, both of Santa Clara, Calif.; Riverbed Technology, Inc. of San Francisco, Calif.; F5 Networks, Inc. of Seattle, Wash.; or Juniper Networks, Inc. of Sunnyvale, Calif.

Clients 102 and server 106 may be provided as a computing device 100, a specific embodiment of which is illustrated in FIG. 1B. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and a client agent 120. The I/O controller 123, in some embodiments, is further connected one or more input devices. As shown in FIG. 1B, the I/O controller 123 is connected to a camera 125, a keyboard 126, a pointing device 127, and a microphone 129.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1B illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include a graphics processor or a graphics processing unit (not shown). The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include a client agent 120, or any portion of a client agent 120. The computing device 100 may further include a storage device 128 that can be either one or more hard disk drives, or one or more redundant arrays of independent disks; where the storage device is configured to store an operating system, software, programs applications, or at least a portion of the client agent 120. A further embodiment of the computing device 100 includes an installation device 116 that is used as the storage device 128.

Embodiments of the computing device 100 include any one of the following I/O devices 130A-130N: a camera 125, keyboard 126; a pointing device 127; a microphone 129; mice; trackpads; an optical pen; trackballs; microphones; drawing tablets; video displays; speakers; inkjet printers; laser printers; and dye-sublimation printers; touch screen; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems such as WINDOWS 3.x; WINDOWS 95; WINDOWS 98; WINDOWS 2000; WINDOWS NT 3.51; WINDOWS NT 4.0; WINDOWS CE; WINDOWS XP; WINDOWS VISTA; and WINDOWS 7; the different releases of the Unix and Linux operating systems; any version of the MAC OS manufactured by Apple Computer; OS/2, manufactured by International Business Machines; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook; a device of the IPOD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein.

In other embodiments the computing machine 100 can be a mobile device such as any one of the following mobile devices: a JAVA-enabled cellular telephone or personal digital assistant (PDA), such as the i55sr, i58sr, i85s, i88s, i90c, i95cl, or the im1100, all of which are manufactured by Motorola Corp; the 6035 or the 7135, manufactured by Kyocera; the i300 or i330, manufactured by Samsung Electronics Co., Ltd; the TREO 180, 270, 600, 650, 680, 700p, 700w, or 750 smart phone manufactured by Palm, Inc; any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; or any other handheld mobile device. In yet still other embodiments, the computing device 100 may a smart phone or tablet computer, including products such as the iPhone or iPad manufactured by Apple, Inc. of Cupertino, Calif.; the BlackBerry devices manufactured by Research in Motion, Ltd. of Waterloo, Ontario, Canada; Windows Mobile devices manufactured by Microsoft Corp., of Redmond, Wash.; the Xoom manufactured by Motorola, Inc. of Libertyville, Ill.; devices capable of running the Android platform provided by Google, Inc. of Mountain View, Calif.; or any other type and form of portable computing device.

In still other embodiments, the computing device 100 can be a virtual machine. The virtual machine can be any virtual machine managed by a hypervisor developed by XenSolutions, Citrix Systems, IBM, VMware, or any other hypervisor. In still other embodiments, the virtual machine can be managed by a hypervisor executing on a server 106 or a hypervisor executing on a client 102.

In still other embodiments, the computing device 100 can in some embodiments execute, operate or otherwise provide an application that can be any one of the following: software; an application or program; executable instructions; a virtual machine; a hypervisor; a web browser; a web-based client; a client-server application; an ActiveX control; a Java applet; software related to voice over internet protocol (VoIP) communications like a soft IP telephone; an application for streaming video and/or audio or receiving and playing streamed video and/or audio; an application for facilitating real-time-data communications; a HTTP client; a FTP client; or any other set of executable instructions. Still other embodiments include a client device 102 that displays application output generated by an application remotely executing on a server 106 or other remotely located machine. In these embodiments, the client device 102 can display the application output in an application window, a browser, or other output window.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; or any other protocol able to transmit data among mobile devices.

The computing environment 101 can include more than one server 106A-106N such that the servers 106A-106N are logically grouped together into a server farm 106. The server farm 106 can include servers 106 that are geographically dispersed and logically grouped together in a server farm 106, servers 106 that are located proximate to each other and logically grouped together in a server farm 106, or several virtual servers executing on physical servers. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

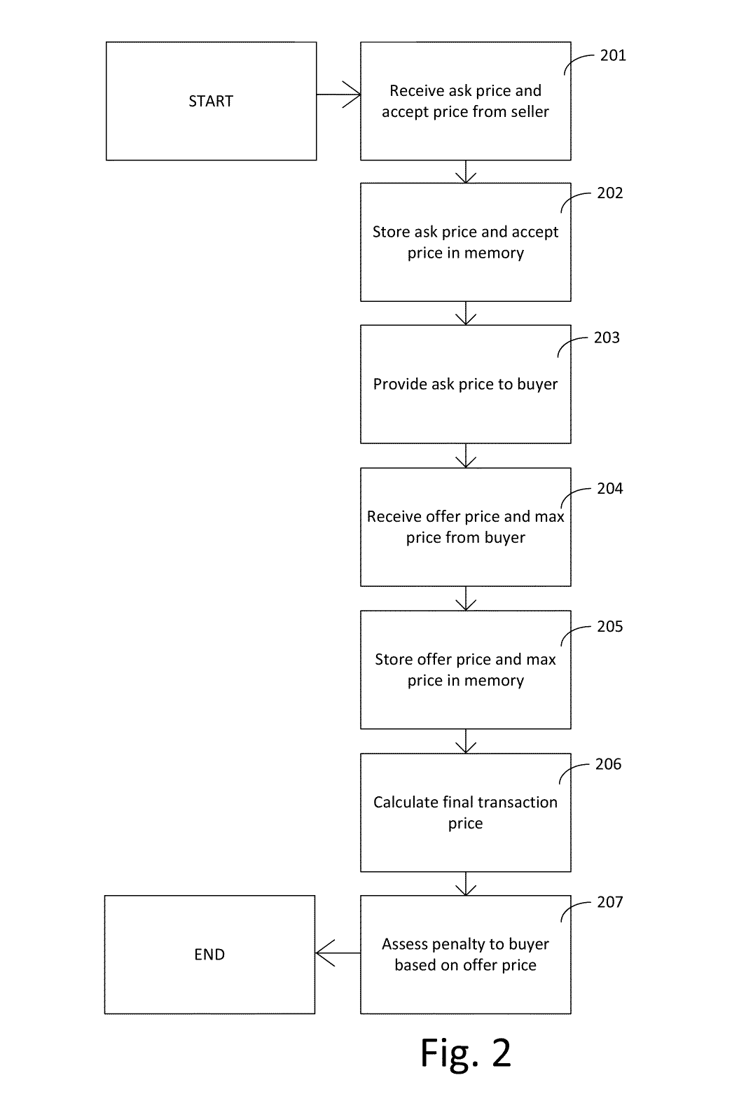

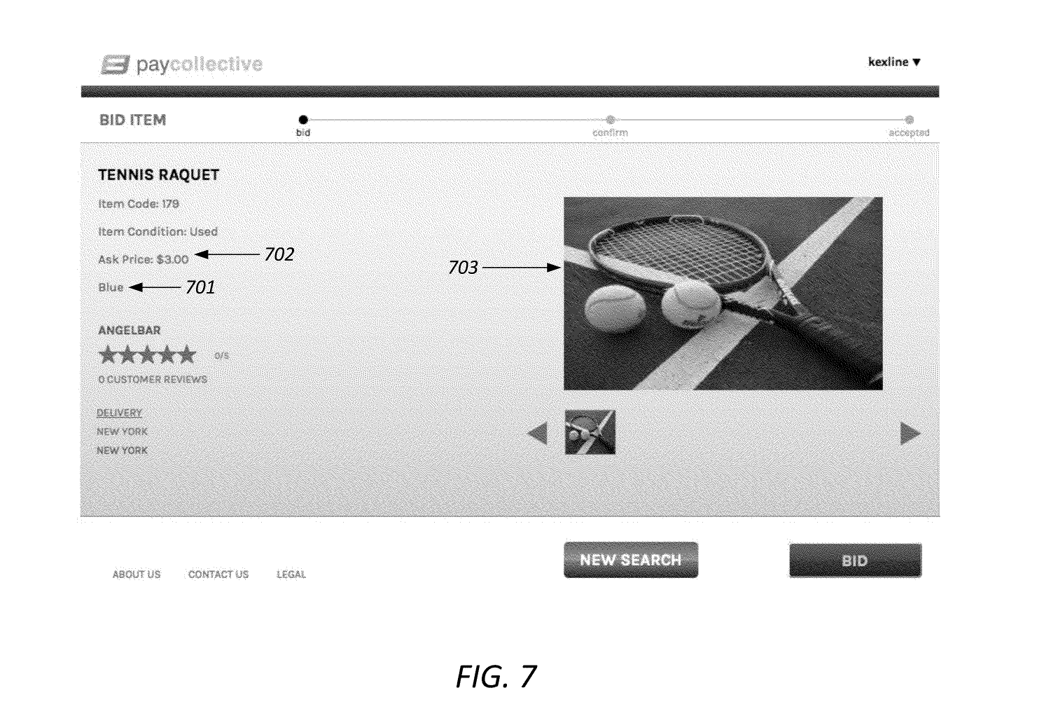

FIG. 2 is a flowchart illustrating a process of automated negotiation in accordance with an embodiment of the present invention. At block 201 the process begins when the automated negotiation system receives price information from the seller. The price information includes an ask price, which will be presented to the buyer, and a accept price representing the lowest sale price the seller is willing to accept. The accept price preferably is not disclosed to anyone other than the seller, as knowledge by others of the seller's accept price could be used to gain an unfair advantage in the automated negotiation process. The process continues to block 202, where the ask price and the accept price are stored in memory. The process continues to block 203, where the ask price is provided to the buyer. According to some embodiments the ask price may be provided as part of an advertisement (see, e.g., FIG. 7, element 702). In other embodiments the ask price may be provided in response to an inquiry about an item (e.g., an item may be listed in an advertisement without a listed price, requiring the buyer to inquire). The process continues to block 204, where an offer price and a max price are received from the buyer. The offer price represents the initial offer by the buyer in the automated negotiation in response to the seller's asking price. The max price represents the highest price that the buyer is willing to pay for the item. The process continues to block 205, where the offer price and the max price are stored in memory.

The process continues to block 206, where a final transaction price is calculated. The final transaction price is calculated according to an automated negotiation algorithm. According to one exemplary automated negotiation algorithm, the final transaction price is calculated as the midpoint between max price and the accept price. For example, a seller may post a set of skis for sale at an ask price of $300, while maintaining a secret accept price of $200. A buyer may then submit a bid in which the offer price is $150, and the max price is $250. The final transaction price would then be calculated as the midpoint between $250 and $200, i.e., $225.

The preceding technique for calculating the final transaction price preferably only is used if the max price is greater than or equal to the accept price. In the case where the max price is less than the accept price, there is no price which falls within both of the acceptable ranges provided by the seller and the buyer. In such a case, the automated negotiation process may fail to result in a transaction. For example, if the buyer had instead submitted a bid in which the offer price is $100, and the max price is $175, no deal could be made, because the buyer is unwilling to pay over $175, but the seller is unwilling to accept less than $200.

According to another exemplary automated negotiation algorithm, the final transaction price is calculated differently than above if the offer price exceeds the accept price. In this case, the final transaction price may be calculated as the midpoint between the offer price and the max price. Accordingly, a final transaction price is calculated which is within both the buyer's stipulated price range and the seller's stipulated price range. For example, if the buyer in the previous example had submitted a bid in which the offer price is $240 and the max price is $260, the final transaction price would be calculated to be the midpoint of $260 and $240, i.e., $250. (This differs from the first exemplary algorithm presented, according to which the final transaction price would have been calculated as the midpoint between $240 and $200, i.e., $220, or $20 less than the buyer's offer.)

As the above example shows, if the final transaction price were instead calculated as the midpoint between the max price and the accept price, the final transaction price would be within the seller's stipulated price range and below the buyer's stipulated price range. While the buyer likely would not be disappointed by such a result, such an arrangement could be skew the automated negotiation process to favor buyers generally, thus making the arrangement less attractive for sellers. In the alternative arrangement according to which the final transaction price falls within the price ranges of both parties, the final transaction price may appear to be a compromise on the part of both parties relative to their price ranges. Neither party is likely to get approximately the best price he or she asks for, but neither party is likely to have to settle for approximately the worst price he or she was willing to accept.

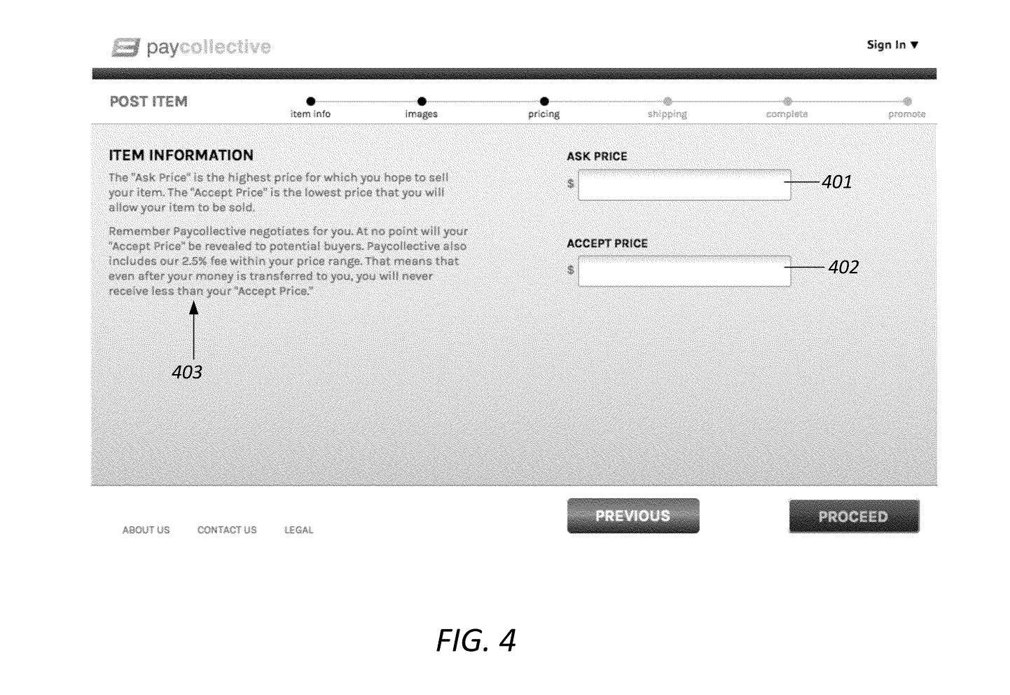

The final transaction price also may be calculated to include a transaction fee assessed by the automated negotiation system. As indicated, e.g., by notification text 403 in FIG. 4, the embodiment illustrated there assesses a transaction fee of 2.5% of the sale price. The transaction fee is included in the final transaction price to be paid by the buyer. Accordingly, the seller receives the final transaction price paid by the buyer, minus the transaction fee. In some embodiments a transaction fee (e.g., 2.5% of the sale price) also may be paid by the seller. The transaction fee paid by the buyer and seller in such an embodiment may be the same percentage of the sale price, or the buyer and seller may pay different percentages of the sale price. A transaction fee also may be assessed in other ways such as a flat fee, or a percentage fee having one or both of a minimum and maximum fee. In other embodiments the transaction fee may be assessed only against the buyer. In yet further embodiments, the transaction fee may be paid only by the seller, and not by the buyer. In some embodiments, the transaction fee(s) may be built in to the negotiation process, such that the final agreed upon price already reflects the transaction fee, and/or such that the final agreed upon price only is reached by automated negotiation if the net cost/profit after transaction fees realized by the buyer/seller respectively falls into the user's indicated price range. In such an embodiment, a buyer and seller may in some cases fail to achieve a mutually agreeable price by automated negotiation due to the restrictions arising from the transaction fees. Such an arrangement can help to prevent “sticker shock” to a user who expects to achieve a certain price for an item, only to see the final value be outside of the expected range due to a final value fee and/or money transfer fee that may lower that price substantially.

After the final transaction price is calculated at block 206, the process proceeds to block 207, where a penalty is assessed to the buyer based on the offer price. Buyers are expected to recognize that negotiation is an attempt to bring two parties together from their initial positions to meet in the middle. Indeed, exemplary automated negotiation algorithms discussed above operate according to this general principle. Successful negotiation also requires an assurance that neither party can unilaterally dictate the terms of a final agreement, however. A purely “split-the-difference” algorithmic approach to reconciling the price ranges of a buyer and seller is vulnerable to exploitation. A savvy buyer might attempt to game the system by providing an unrealistically low offer price if there is not an incentive built into the negotiation process to provide a higher initial offer. In conventional negotiations, an absurdly low offer (e.g., offering to buy the pair of skis discussed above for $1) may be treated as a clear sign that the buyer is not attempting to negotiate in good faith.

Parties who do not negotiate in good faith often fail to achieve favorable outcomes because the opposing parties in the negotiation will punish the lack of good faith in a variety of ways. An aggrieved negotiating party may simply refuse to do any further business with the bad faith negotiator, thereby ensuring that the bad faith negotiator will not succeed. Alternatively, the aggrieved party may continue in the attempts to negotiate, but may be less inclined to be flexible, only agreeing to terms that are more favorable to the aggrieved party than what would have been considered acceptable before the bad faith negotiation was observed.

Similarly, an automated negotiation system can regulate behavior of negotiating parties by applying penalties. In some embodiments of the present invention, there is less reason to worry that a seller will attempt to game the system than a buyer. This is in part because the seller makes the first move in the negotiation by providing his or her price range. If the ask price is too high, buyers will not be interested and the seller will not be able to sell the item, and if the ask price is too low, any resulting deal will be at an undesirably low final transaction price. Similarly, if a buyer provides a max price that is too low, no deal can be reached, and the buyer will be unable to buy the desired item, and if the max price is too high, any resulting deal will be at an undesirably high final transaction price. Similarly, if the offer price is too high, any resulting deal will be at an undesirably high final transaction price.

There is a worry, however, that a buyer will provide an unreasonably low offer price. In the algorithms described above, the only use of the offer price is to increase the final transaction price if the offer price exceeds the accept price. Therefore, there is no built-in incentive for the buyer to provide a realistic offer price.

According to certain embodiments of the present invention, a penalty is assessed to the buyer when the offer price is below a cutoff value. According to some embodiments the cutoff value may be a predetermined percentage of the accept price. For example, if the offer price is less than half of the accept price, the automated negotiation system may determine that the bid is not a good-faith bid and apply a penalty. Thus if, e.g., a seller has a price range of $300 ask price and $200 accept price, a buyer who has a max price of $250, but an offer price of $50, would be assessed a penalty (because $50 is less than half of $200, i.e., $100). However, if both of the max price and the offer price are far lower than the seller's prices, it may be the case that the buyer simply does not want to negotiate in the same price range as the seller, in which case assessing a penalty may be unnecessary, as no deal will be struck regardless. Such an arrangement has the advantage that the accept price is unknown to the buyer, and thus the buyer cannot game the system by calculating the optimum bid based on the available information.

One way of assessing a penalty to a buyer in an exemplary automated negotiation system is to adjust the final transaction price in the seller's favor. For example, if the seller's range is $300 ask price and $200 accept price, and the buyer's range is $250 max price and $50 offer price, the process shown in FIG. 2 may determine at block 206 that the final transaction price is the midpoint between $250 and $200, i.e., $225. However, since the offer price was low enough to trigger a penalty at block 207, the automated negotiation system may adjust the final transaction price upward. The adjustment may entail addition of a predetermined percentage of the final transaction price. If the predetermined percentage is 10%, e.g., the final transaction price will be adjusted upward $22.50 from $225 to $247.50. If, however, the final transaction price after adjustment would exceed the max price, this adjustment may be undesirable. According to some embodiments, the automated negotiation system may set the final transaction price to the max price and complete the deal. Alternatively, the automated negotiation system may decide that such a bid fails and not complete a transaction.

According to some embodiments, the penalty to the buyer may be assessed “silently,” i.e., without disclosing to either party that the final transaction price includes a penalty. This arrangement could serve to prevent “repeat offenders” from refining their strategy in successive auctions by determining, through trial and error, where sellers are setting their accept prices (or at least what the cutoffs are for being penalized). It is preferred, however, that buyers are warned that attempts to game the system by submitting unrealistic bids may be monitored and penalized, as the deterrent value of the penalty requires that the buyer have reason to suspect that a penalty may be assessed. Alternatively, the penalty to the buyer may be assessed overtly, i.e., the buyer is alerted to the fact that the final transaction price includes a penalty. One reason for instituting such an arrangement would be so that repeat customers of the automated negotiation website become aware of the fact that their unreasonable bidding practices are being punished, thereby providing the incentive to bid reasonably in future automated negotiations.

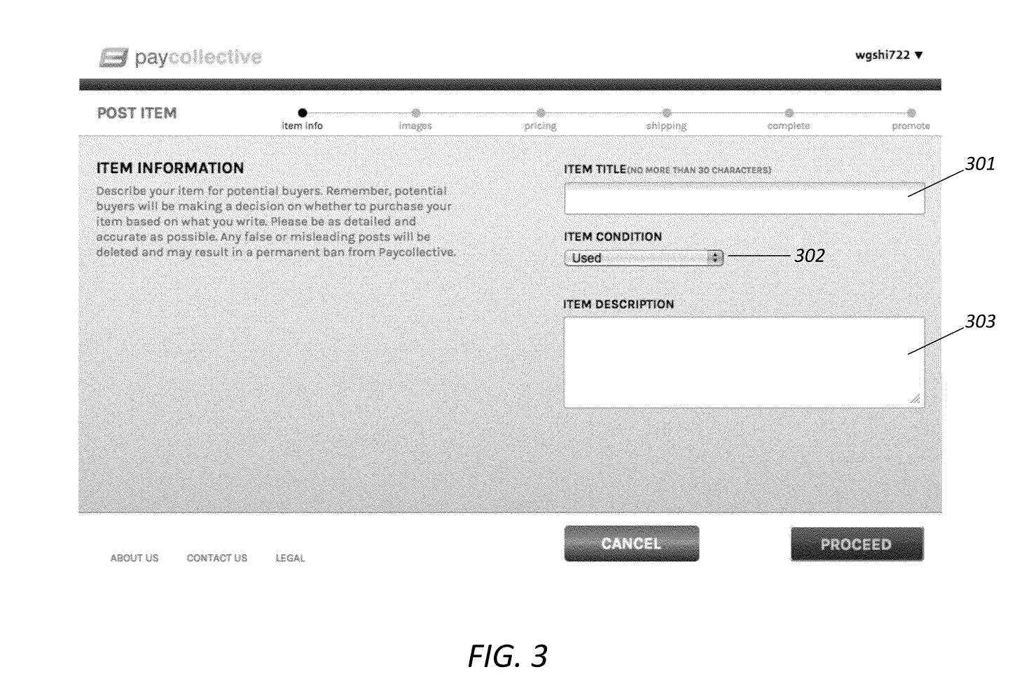

FIG. 3 is a screenshot of a data entry screen from an automated negotiation system allowing a seller to enter a description of an item for sale. In the context of the present application, an “item” may include both tangible items, such as electronic devices, motor vehicles, real estate, etc., and non-tangible items, such as monetary instruments and agreements to provide services. According to the embodiment shown in the FIG. 3, a seller may list an item for sale. The seller begins by describing the item in the data entry fields provided. In alternative embodiments, any information may be provided not only via data entry fields, as described herein, but in any manner known in the art, non-limiting examples of which include selecting a radio button to indicate a value for a field, data entry using voice recognition, motion capture, uploading a configuration file, and submitting data in the body of an email. In a first data entry field 301 the seller may enter a title describing the item in brief. The title may later be used in conjunction with a listed advertisement as a brief description of the advertised item. For example, in an advertisement listing service, numerous advertisements may be listed for a potential buyer such that the buyer sees essentially only the titles of the advertisements. In such an embodiment the titles may also serve as links to the full advertisements, which may only be displayed when the link is followed.

A second data entry field 302 is provided whereby the seller may indicate a condition of the item, such as if the item is used, broken, new, etc. In some embodiments, the seller may list items other than tangible, movable goods, such that the condition of the item may be described differently, or may not be an applicable concept. For example, if the seller is listing real estate, the condition of the item may indicate the age of the physical plant, whether the unit is move-in ready, etc. If the seller is listing intangible services, e.g. a dog-walking service, a snow-removal service, a discount coupon for use at a local business, etc., the item condition may be inapplicable, or may alternatively be used to indicate information such as whether the service is licensed, insured, etc.

In a third data entry field 303, the seller may enter a detailed description of the item that is to be offered for sale. According to some embodiments, this field may be hidden from a potential buyer until the potential buyer follows a link associated with the item title provided in data entry field 301. In other embodiments, the first two data entry fields 301, 302 may be optional or omitted and the detailed description may be the only description provided by the seller. The detailed description may include any information the seller wishes to provide, including size and condition of the item, reasons for selling the item, suggested uses for the item, a review of the seller's experiences with using the item, or anything else that the seller wishes to include in an advertisement. According to some embodiments the seller may intentionally exclude pricing information from the detailed description. In other embodiments, the seller may provide information relating to things such as the seller's willingness or unwillingness to negotiate the price, information supporting the reasonableness of seller's proposed, etc. The seller's specification of pricing information is discussed below with respect to FIG. 4.

FIG. 4 is a screenshot of a data entry screen allowing a seller to submit an offer to sell in accordance with an embodiment of the present invention. The seller may submit an asking price via data entry field 401 and an accept price via data entry field 402. The asking price defines the price that is to be displayed to potential buyers in association with an advertisement for the item. The accept price, however, preferably is not revealed to any buyer. The accept price (or “reserve price”) indicates the lowest amount of money that the seller is willing to accept as the result of an automatically negotiated agreement to sell. According to some embodiments an automatically negotiated final sale price may include a transaction fee that is collected by automated negotiation system. Notification text 403 shows that in the illustrated embodiment a fee is assessed at 2.5% of the negotiated price.

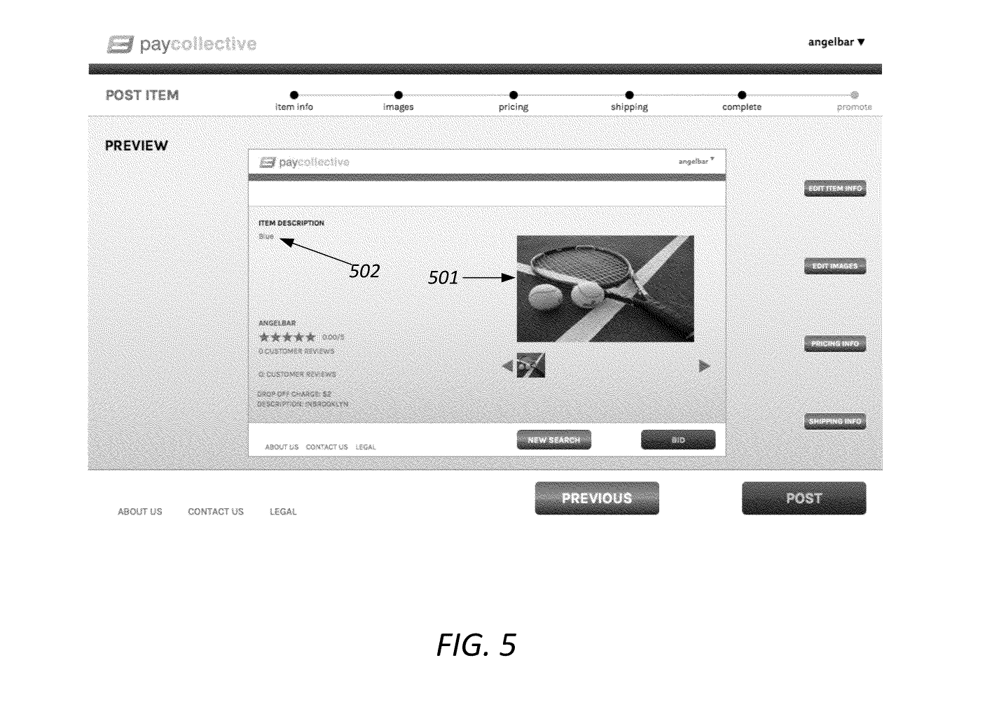

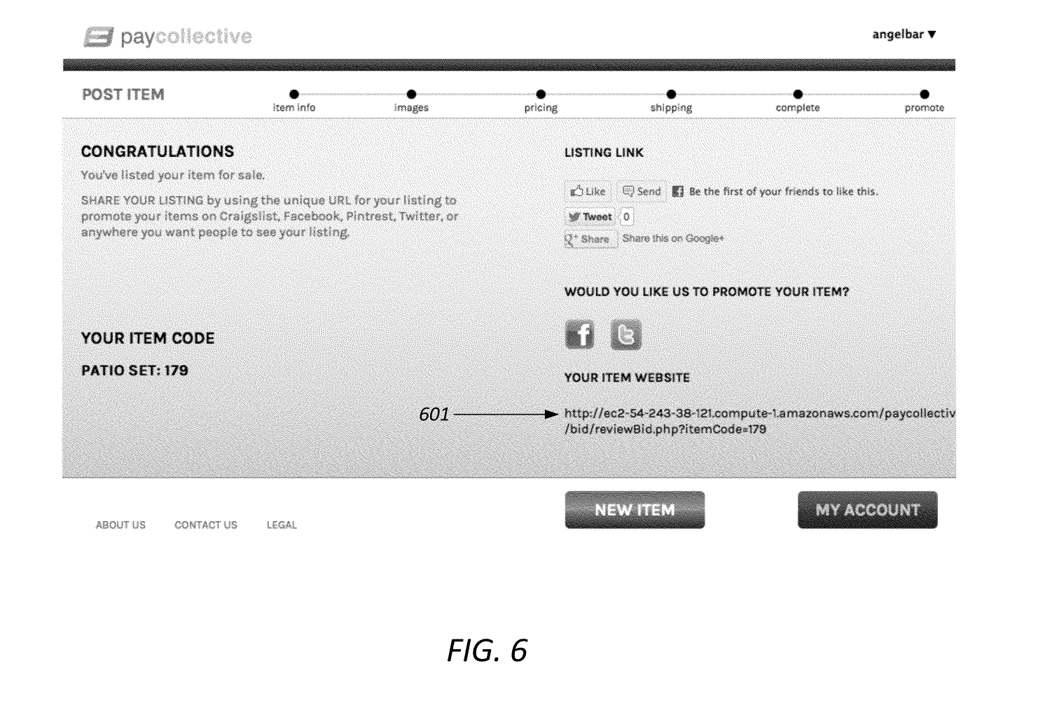

FIG. 5 is a screenshot of a preview of an advertisement. The advertisement may include one or more photographs 501 of the item and a detailed description 502 of the item. In some embodiments, an asking price of the item also may be presented in the advertisement preview. In addition, the advertisement may include a link that will be associated with the advertisement. The link may be shareable according to various techniques known in the art. For example, according to some embodiments the link may be an HTML hyperlink. Such links may be published and transmitted in any fashion that textual information may be transmitted, such as via email; posting on websites such as special-interest websites (e.g. a link to an advertisement for a musical instrument may be posted to a website geared toward musicians), social media websites, and online marketplace websites; printing to paper for distribution via bulletin boards, etc. FIG. 6 is a screenshot of a confirmation that the advertisement of FIG. 5 has been listed. According to the illustrated embodiment in FIG. 6, where the listing has been completed, the advertisement is available at link 601. According to alternate embodiments, a link may be provided prior to the listing being completed, or a preview link may be provided that is different from the final link.

FIG. 7 is a screenshot of an advertisement in accordance with an embodiment of the present invention. When a seller posts an item for sale, the corresponding advertisement may then be viewable by potential buyers. The advertisement shown in FIG. 7 includes information that was provided in the data entry fields shown in FIGS. 3 and 4, including a detailed description 701 of the item, an asking price 702 and a picture 703 of the item.

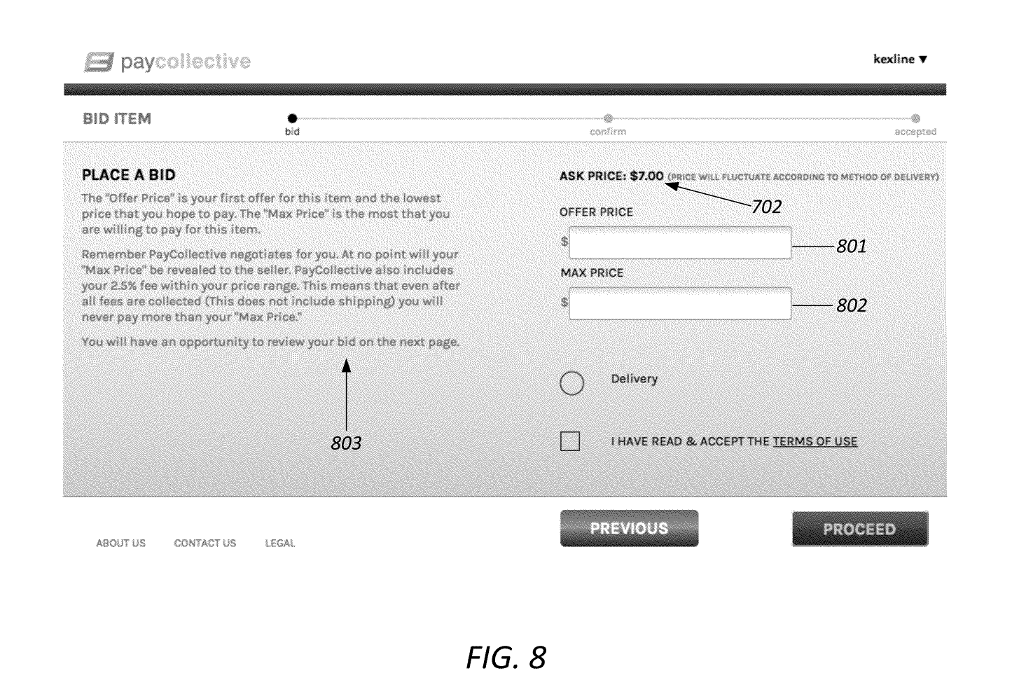

FIG. 8 is a screenshot of a data entry screen allowing a buyer to submit an offer to buy in response to the advertisement of FIG. 3. When a buyer views an advertisement and decides to make an offer, the buyer may be presented with a screen such as the one shown in FIG. 8. The buyer may be shown the seller's asking price 702 for reference. The buyer is presented with data entry fields 801 and 802 for entering an offer price and a maximum price, respectively. The offer price represents the buyer's initial bid in the automatic negotiation. The maximum price represents the highest price that the buyer is willing to accept as the result of the automatic negotiation. In the presently illustrated embodiment, the buyer is also informed by notification text 803 that a transaction fee (2.5% of the negotiated price, in this case) will be assessed by the automatic negotiation system.

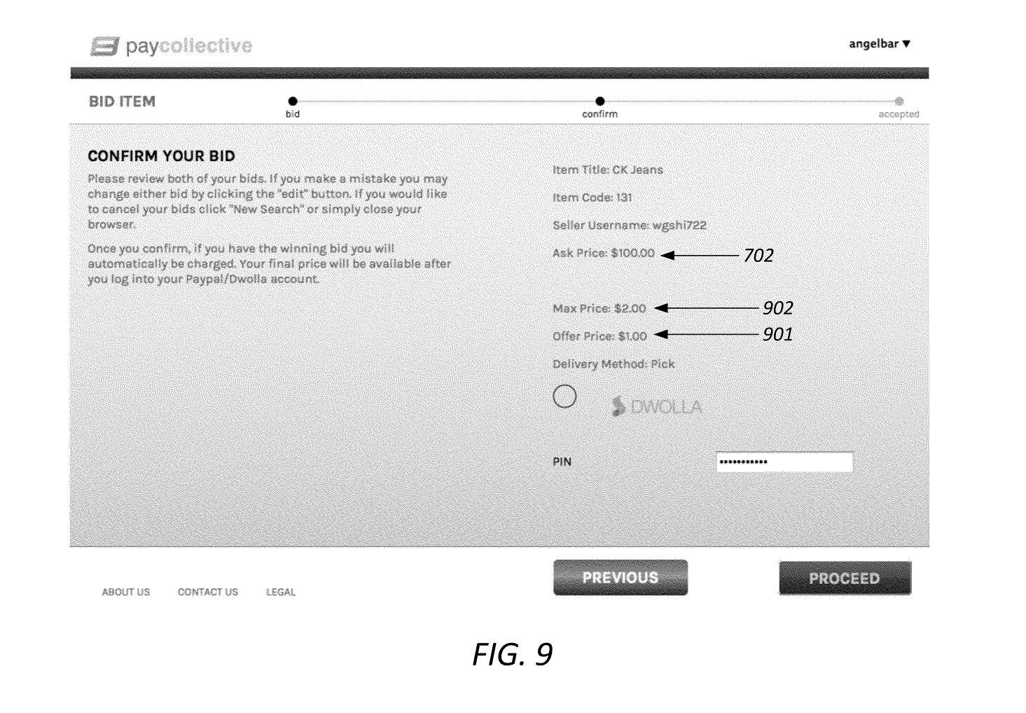

FIG. 9 is a screenshot illustrating an offer that was submitted via the data entry screen of FIG. 4. In the presently illustrated embodiment, the buyer is presented with a confirmation screen after entering a bid (i.e., an offer price and a maximum price) for the item. The buyer is reminded of the asking price 702, and the offer price 901 and maximum price 902 that the buyer entered at the previous screen are displayed to the buyer so that the buyer may review the bid for accuracy, and so that the buyer may take some more time to deliberate over whether the bid meets with the buyer's approval.

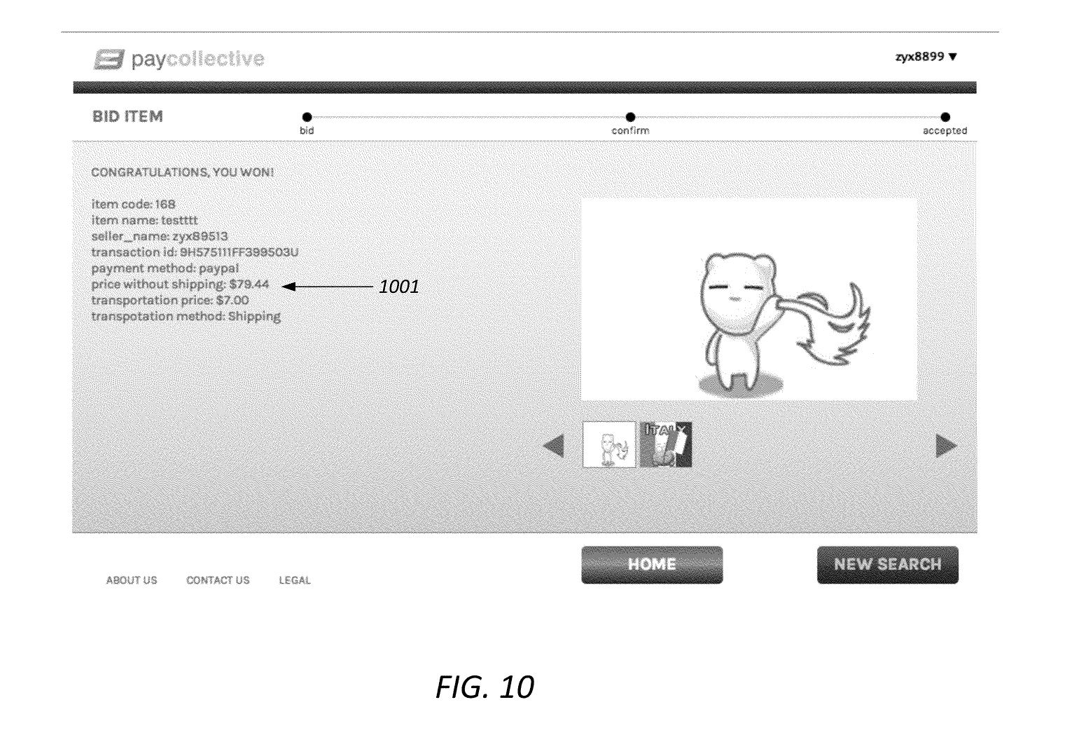

FIG. 10 is a screenshot of a message indicating that a sale price has been established in response to the offer of FIG. 5. Once the buyer submits a bid for the item, automated negotiation begins and the automated negotiation system immediately determines whether an agreement is or is not reached. In the illustrated example, an agreement was reached, and the buyer is informed that the final sale price 1001 is $79.44 plus $7.00 shipping. According to certain embodiments, the final negotiated price may be inclusive of shipping costs. The method of delivery may be included in the bid, in which case the method of delivery may be included as part of the bid. Alternatively, the buyer may be presented with various delivery options to choose from, and the buyer may select one of these options only after automated negotiation has taken place. In this case, the total negotiated price may be independent of delivery costs, which may be the responsibility of the buyer. In the illustrated embodiment, a buyer has bid with a maximum price that was higher than $86.44 ($79.44 plus $7.00 shipping) and an offer price lower than this amount, while the seller has posted the item for sale with an asking price higher than this amount, but with an accept price (never shown to the buyer) lower than this amount. The final sale price 1001 is higher than the buyer's offer price, representing the buyer's concessions achieved by the automated negotiation process, but the final sale price 1001 also is lower than the seller's asking price, representing the seller's concessions achieved by the automated negotiation process. The final sale price 1001 also does not exceed the buyer's maximum price, which was not disclosed to the seller. The final sale price 1001 also is not lower than the seller's accept price (not shown in the figures), which was not disclosed to the buyer. Accordingly, both the buyer and the seller were successful, in that they obtained an agreement to complete the transaction at a price that was more favorable than the initial position of the other party while themselves not conceding beyond a predefined limit.

In a case where the automated negotiation process fails to achieve an agreement, the automated negotiation system may present a similar screen to the buyer indicating that the negotiation was unsuccessful. In some embodiments, the buyer might be encouraged to try again by submitting revised numbers in a new bid. In other embodiments, however, in case of a failed negotiation the buyer might be prevented from submitting further bids on the item indefinitely, or for a predetermined period of time, such as 3 hours, 12 hours, one week, etc. Additionally, according to some embodiments the automated negotiation system may, in case of a failed bid, prevent the buyer from submitting bids on other advertisements for a set period of time as well.

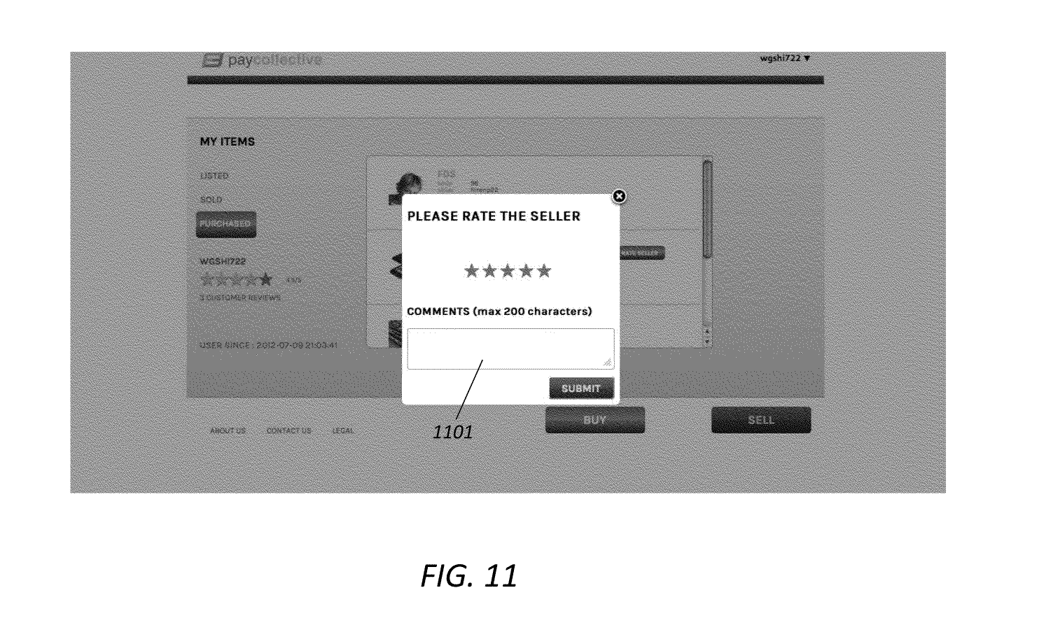

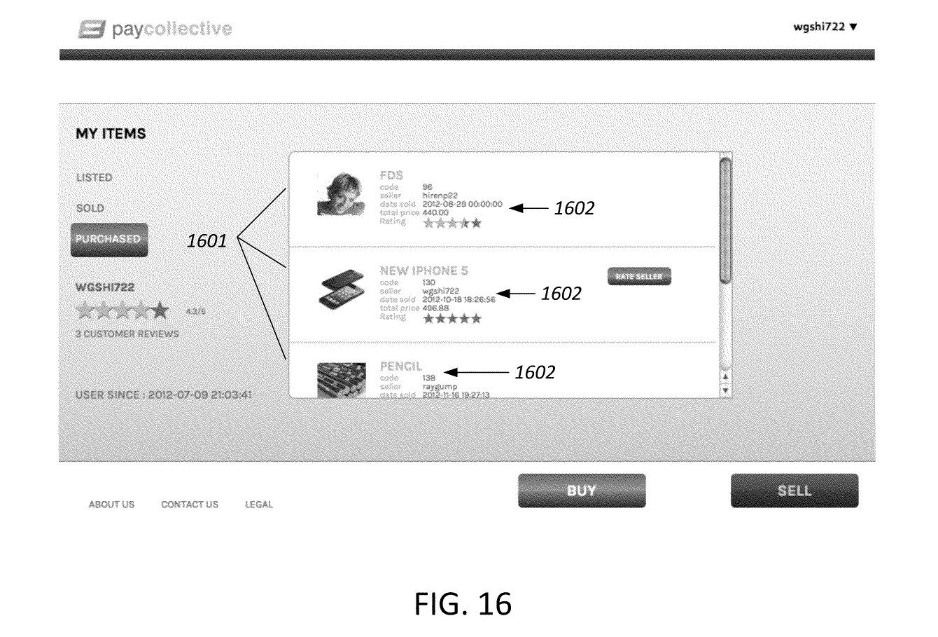

FIG. 11 is a screenshot of a data entry screen allowing a buyer to provide feedback about a seller. Text entry box 1101 is presented to a buyer who has just completed a purchase. In other cases, the buyer may be shown text entry box 1101 after choosing to view a list of previously completed purchases and selecting one for which to provide feedback. A screenshot of one such listing of items 1602 that have been purchased is shown in FIG. 16. Returning to FIG. 11, the user may use the view of FIG. 11 to see which items he or she has purchased in the past. The buyer also may rate the seller on a numerical scale, e.g. ranging from 1 star (very negative) to 5 stars (very positive). In certain embodiments information may be collected reflecting experiences that buyers and/or sellers have had with other users of the system. For example, if a seller advertises an item for sale but then fails to deliver it or delivers something else, the buyer may post comments regarding the experience. If that seller then proceeds to post other items for sale, potential buyers for these later items may view the negative comments and take that additional information into consideration when deciding whether or not to bid on the item. Similarly, a buyer who is distrustful of a seller, e.g., based on negative feedback, may still wish to bid on an item, but may be less willing to place a high bid, so as to minimize the risk of loss in case the transaction runs into difficulty. In other cases, a buyer may wish to leave positive comments to indicate that a seller met and/or exceeded expectations, thereby helping the seller to develop a positive reputation.

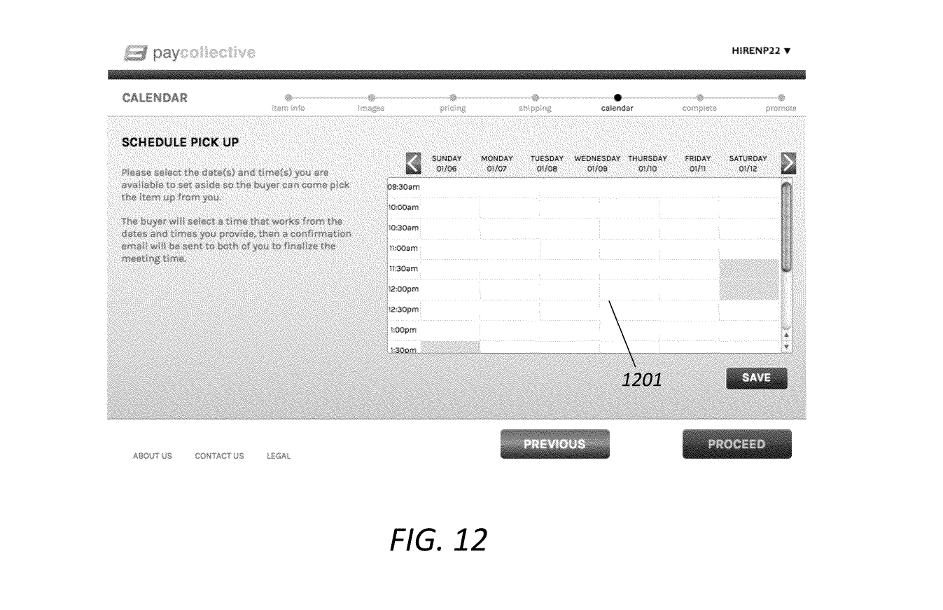

FIG. 12 is a screenshot of a data entry screen allowing a seller to provide information for use in scheduling pick up of an item. A calendar 1201 is presented to the seller, which allows the seller to input one or more dates and times during which the seller is available to have a buyer come pick up the item that has been sold. Upon selling the item, the times entered in calendar 1201 can be provided to the buyer, e.g., in a calendar similar to calendar 1201, and the buyer can then select one of the times and set up an appointment to pick up the item. In some cases, the buyer may be able to select more than one of the presented times, in which case the system may determine a final agree-upon time based on other information, such as ordered preferences provided by the buyer and/or seller, other transactions corresponding to the buyer and/or seller, etc. In other cases, the times may be presented to the buyer prior to the sale of the item. In such circumstances, the buyer may choose to purchase or not to purchase the item based on the available times. Alternatively, the buyer may choose a different mode of delivery if necessary, such as shipping, which may entail additional costs.

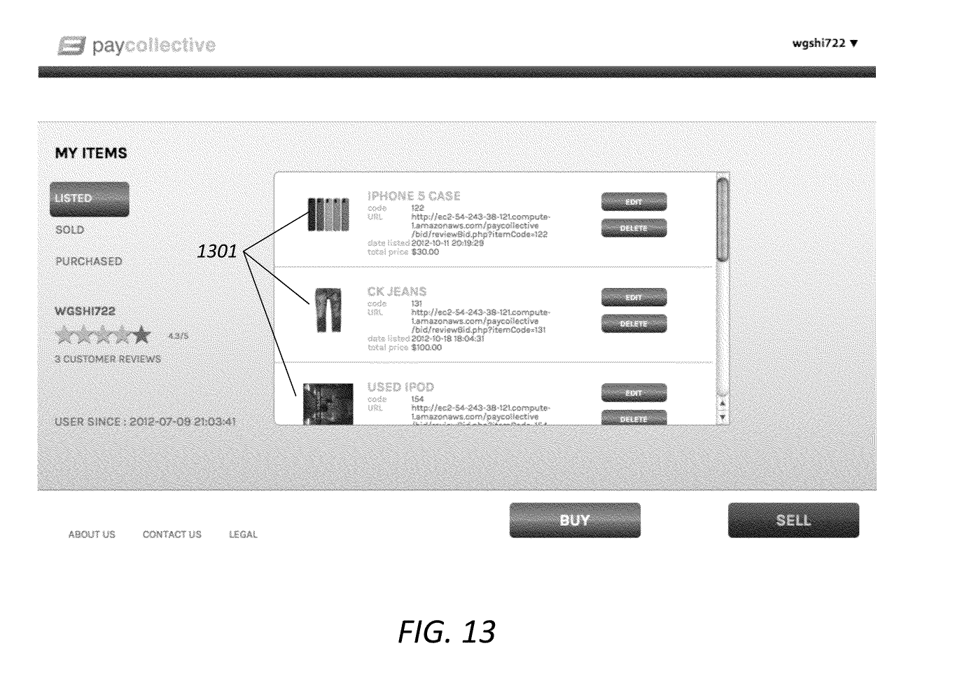

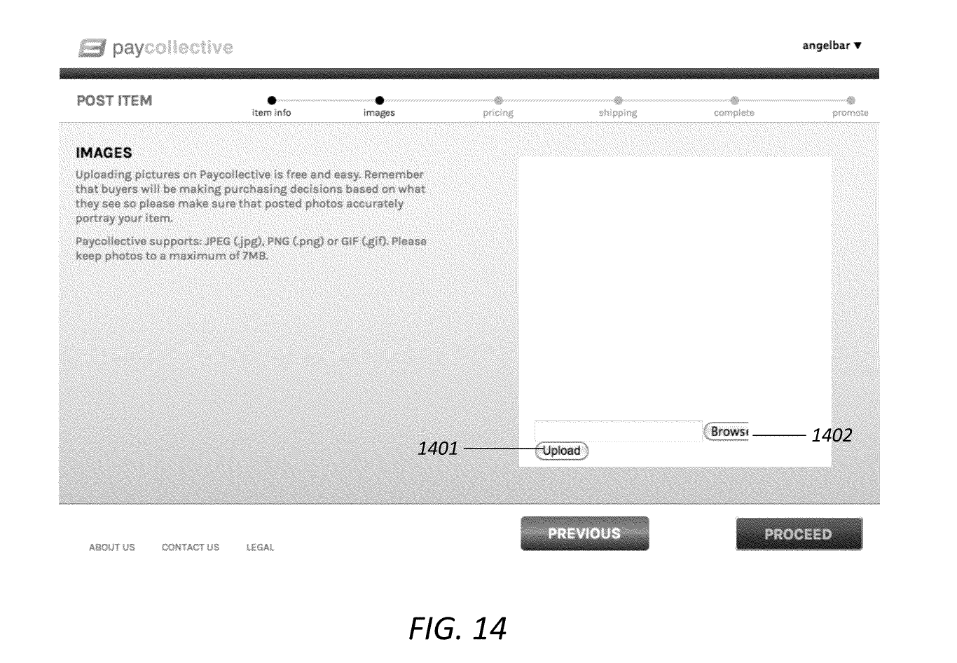

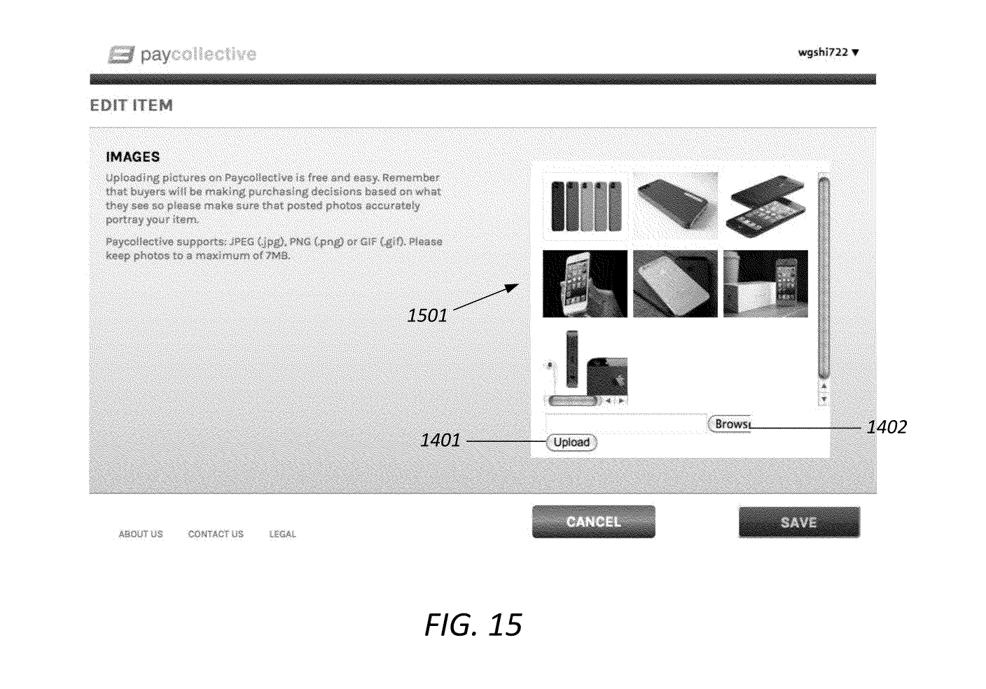

FIG. 13 is a screenshot of a listing of items 1301 that have been posted for sale. The seller may use this view to see which items still are up for sale, as well as to remove or edit one or more items. For example, the seller may decide that an item should not be sold, and the seller can cancel the posting so that it no longer is available. Alternatively, the seller may update a item listing, e.g., by changing the asking price and/or minimum price or changing the description. The seller also may provide additional images of the item. FIGS. 14 and 15 are screenshots of data entry screens allowing a seller to provide images for use in advertisements. These entry screens may be presented to a seller upon posting an item for sale. Alternatively, these entry screens may be presented to the seller if the seller decides to add one or more images to an existing listing, e.g., by editing the item through the listing shown in FIG. 13. The seller may select the “browse” button 1402 to browse the seller's local computer files for images. A collection of image thumbnails 1501 may be displayed based on the files that are found there. Alternatively, or in addition, the image thumbnails 1501 may include images that previously have been uploaded by the seller. Upon selecting one or more images to be used in the advertisement, the seller can confirm the selection by clicking the “upload” button 1401.

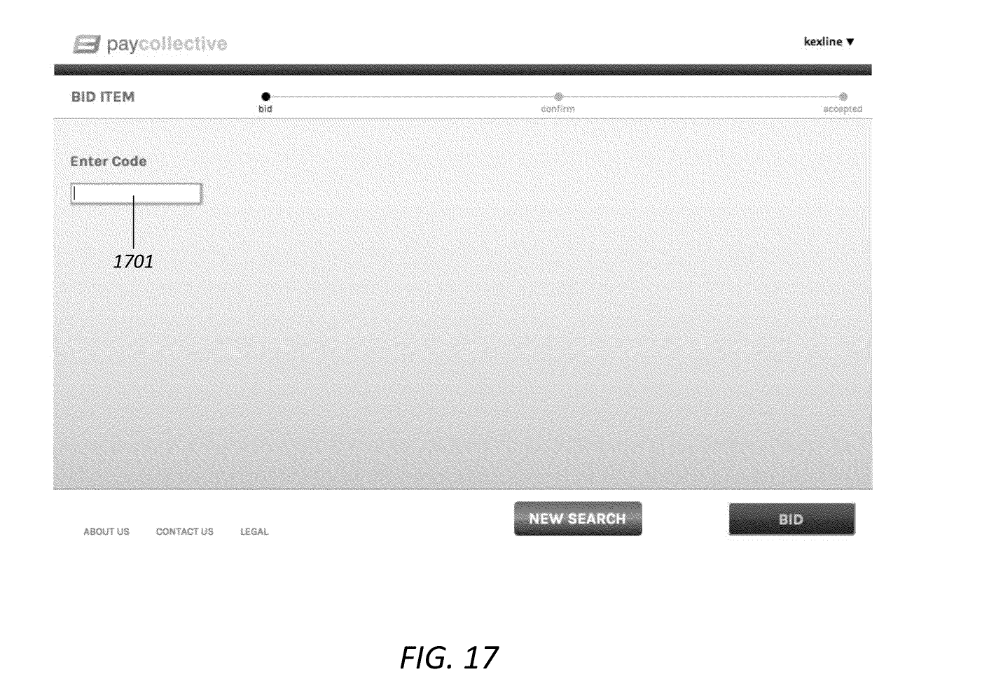

FIG. 17 is a screenshot of a data entry screen allowing a buyer to select an item on which to bid. In some cases, a buyer may navigate through a selection of advertisements shown in a user interface to arrive at a screen allowing the buyer to bid on an item. In other cases, however, the buyer may be in possession of a unique code corresponding to an item for sale. In such a case, the buyer may enter that code in a text entry box 1701, and the system can immediately proceed to accepting the buyer's bid for that item. The buyer may receive the code in various ways, such as by email, text message, telephone, etc., or may simply recall the code from a previously viewed advertisement.

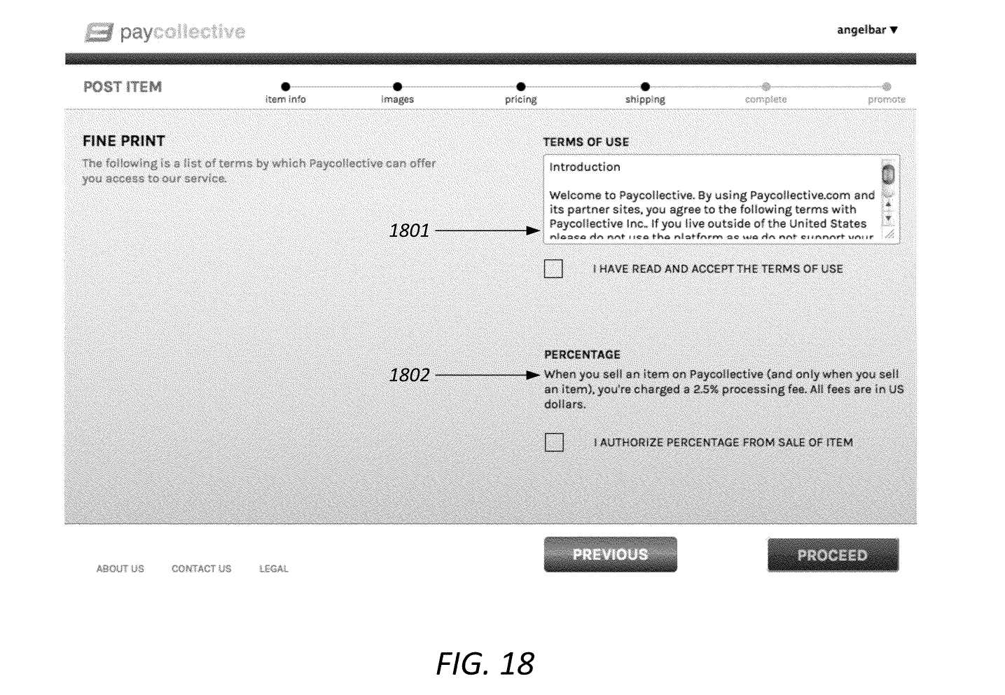

FIG. 18 is a screenshot illustrating information that is provided to a seller posting an item for sale. When a seller posts an item for sale, the seller may be required to view and agree to terms of use 1801 specified by the system. Similarly, the seller may be presented with notification text 1802 informing the seller of a processing fee associated with any transactions performed using the system, and may be required to agree to the processing fee, as well.

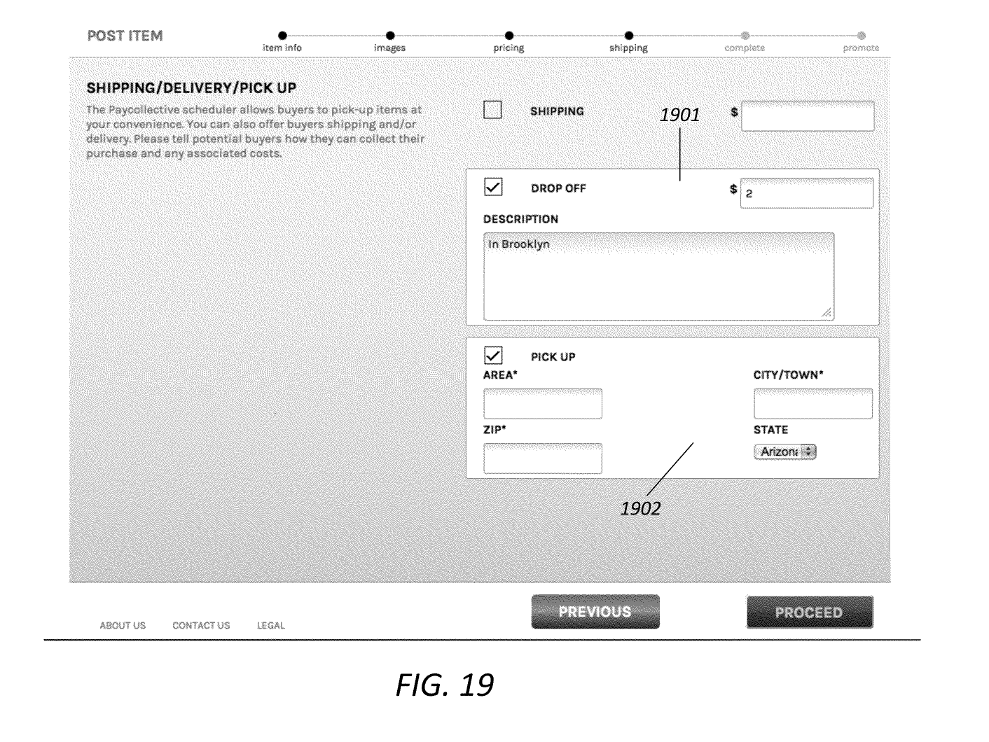

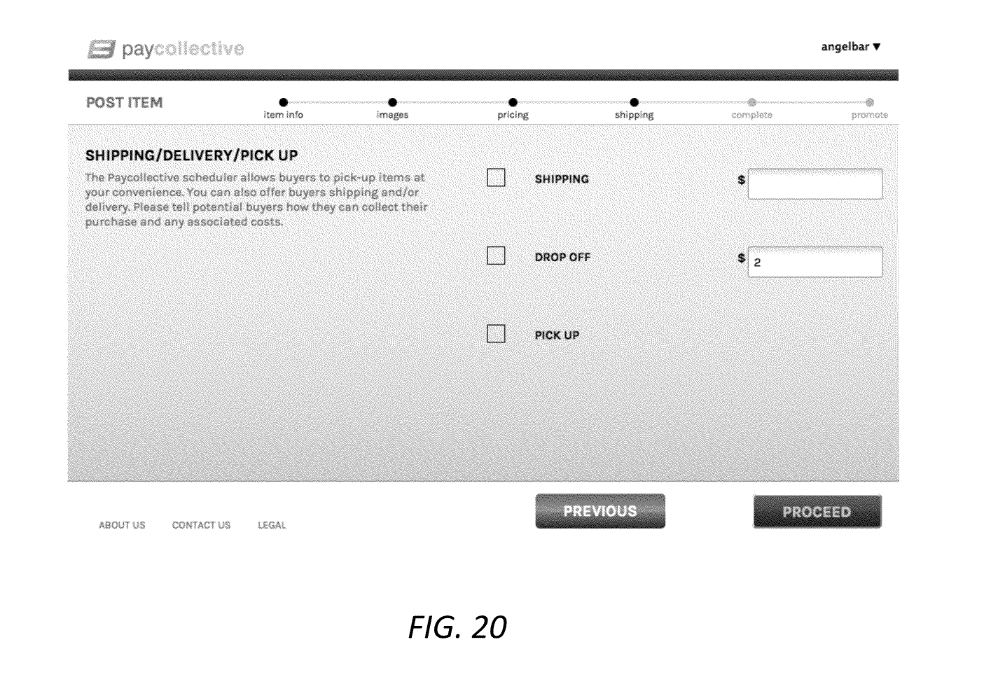

FIGS. 19 and 20 are screenshots of data entry screens allowing a seller to provide information for use in arranging for delivery of an item. When a seller posts an item for sale, the seller also may provide information relating to how the item may be delivered. In some embodiments, the seller may be required to provide certain information relating to delivery. In the illustrated embodiment, the seller may enter information relating to drop off options in text entry box 1901. The seller can provide information here regarding one or more areas where the seller will agree to drop the item off if requested. The seller also may indicate an additional fee that will be charged if this method of delivery is selected. The seller also may provide information describing a location where the item may be picked up by the buyer in text entry box 1902. In some embodiments, selecting this delivery option may have no associated delivery fee, e.g., where the address for pick up is the home address of the seller. In other cases, the seller may be able to associate a delivery charge with this option, e.g., where the seller is to deliver the item to the pick up location. The pick up information may be provided to the buyer only upon submission of a winning bid, so as to avoid publicly publishing what may be the seller's home address.

It is to be understood that the figures and descriptions of embodiments have been simplified to illustrate elements that are relevant for a clear understanding, while eliminating, for purposes of clarity, other elements. Those of ordinary skill in the art will recognize, however, that these and other elements may be desirable. However, because such elements are well known in the art, and because they do not facilitate a better understanding, a discussion of such elements is not provided herein. It should be appreciated that the figures are presented for illustrative purposes and not as constriction drawings. Omitted details and modifications or alternative embodiments are within the purview of persons of ordinary skill in the art.

It can be appreciated that, in certain aspects, a single component may be replaced by multiple components, and multiple components may be replaced by a single component, to provide an element or structure or to perform a given function or functions. Except where such substitution would not be operative to practice certain embodiments, such substitution is considered within the scope of the present invention.

The examples presented herein are intended to illustrate potential and specific implementations. It can be appreciated that the examples are intended primarily for purposes of illustration for those skilled in the art. The diagrams depicted herein are provided by way of example. There may be variations to these diagrams or the operations described herein without departing from the spirit of the invention. For instance, in certain cases, method steps or operations may be performed or executed in differing order, or operations may be added, deleted, or modified.

Furthermore, whereas particular embodiments have been described herein for the purpose of illustrating the invention and not for the purpose of limiting the same, it will be appreciated by those of ordinary skill in the art that numerous variations of the details, materials, and arrangement of elements, steps, structures, or parts may be made within the principle and scope of the invention without departing from the invention.

A number of implementations have been described. Nevertheless, it will be understood that various modifications may be made and that other implementations are within the scope of the invention.

What is claimed is:

1. A method of automated negotiation, implemented using at least one computer, the method comprising:
receiving, from a seller, an ask price for an item and a accept price for the item;
storing the ask price for the item and the accept price for the item in a memory element provided by the at least one computer;
providing the ask price for the item to a buyer;
receiving, from the buyer, an offer price and a max price;
storing the offer price for the item and the max price for the item in the memory element;
calculating a final transaction price using the at least one computer; and
assessing a penalty to the buyer based at least on the offer price.

2. The method of claim 1, wherein:
the final transaction price is a midpoint between the max price and the accept price; and
assessing the penalty to the buyer comprises 1) determining that the offer price is less than a first predetermined percentage of the accept price, and 2) increasing the final transaction price by a second predetermined percentage.

3. The method of claim 2, further comprising generating an advertisement of the item, the advertisement including the ask price for the item.

4. The method of claim 3, further comprising generating a link to the advertisement.

5. The method of claim 4, further comprising providing the link to the seller.

6. The method of claim 3, further comprising:
displaying, to the seller, a first user interface comprising a first calendar;
receiving, from the seller, via the user interface, a first input indicating at least one first time corresponding to the first calendar;
displaying, to the buyer, a second user interface comprising a second calendar, the second calendar including information corresponding to the at least one first time;
receiving, from the buyer, via the user interface, a second input indicating at least one second time corresponding to the second calendar, the at least one second time corresponding to at least one of the at least one first time;
determining, using the first input and the second input, a third time at which the item is to be delivered.

7. An automated negotiation system, comprising:
means for receiving, from a seller, an ask price for an item and a accept price for the item;
means for storing the ask price for the item and the accept price for the item in a memory element provided by the at least one computer;
means for providing the ask price for the item to a buyer;
means for receiving, from the buyer, an offer price and a max price;
means for storing the offer price for the item and the max price for the item in the memory element;
means for calculating a final transaction price using the at least one computer; and
means for assessing a penalty to the buyer based at least on the offer price.

8. The system of claim 7, wherein:
the final transaction price is a midpoint between the max price and the accept price; and
assessing the penalty to the buyer comprises 1) determining that the offer price is less than a first predetermined percentage of the accept price, and 2) increasing the final transaction price by a second predetermined percentage.

9. The system of claim 8, further comprising means for generating an advertisement of the item, the advertisement including the ask price for the item.

10. The system of claim 9, further comprising means for generating a link to the advertisement.

11. The system of claim 10, further comprising means for providing the link to the seller.

12. The system of claim 7, further comprising:
means for displaying, to the seller, a first user interface comprising a first calendar;
means for receiving, from the seller, via the user interface, a first input indicating at least one first time corresponding to the first calendar;
means for displaying, to the buyer, a second user interface comprising a second calendar, the second calendar including information corresponding to the at least one first time;
means for receiving, from the buyer, via the user interface, a second input indicating at least one second time corresponding to the second calendar, the at least one second time corresponding to at least one of the at least one first time;
means for determining, using the first input and the second input, a third time at which the item is to be delivered.

13. At least one computer-readable medium encoded with instructions that, when executed on at least one processing unit, perform a method of automated negotiation, the method comprising:
receiving, from a seller, an ask price for an item and a accept price for the item;
storing the ask price for the item and the accept price for the item in a memory element provided by the at least one computer;
providing the ask price for the item to a buyer;
receiving, from the buyer, an offer price and a max price;
storing the offer price for the item and the max price for the item in the memory element;
calculating a final transaction price using the at least one computer; and
assessing a penalty to the buyer based at least on the offer price.

14. The computer-readable medium of claim 13, wherein:
the final transaction price is a midpoint between the max price and the accept price; and
assessing the penalty to the buyer comprises 1) determining that the offer price is less than a first predetermined percentage of the accept price, and 2) increasing the final transaction price by a second predetermined percentage.

15. The computer-readable medium of claim 14, wherein the method further comprises generating an advertisement of the item, the advertisement including the ask price for the item.

16. The computer-readable medium of claim 15, wherein the method further comprises generating a link to the advertisement.

17. The computer-readable medium of claim 16, wherein the method further comprises providing the link to the seller.

18. The computer-readable medium of claim 13, wherein the method further comprises:
displaying, to the seller, a first user interface comprising a first calendar;
receiving, from the seller, via the user interface, a first input indicating at least one first time corresponding to the first calendar;
displaying, to the buyer, a second user interface comprising a second calendar, the second calendar including information corresponding to the at least one first time;
receiving, from the buyer, via the user interface, a second input indicating at least one second time corresponding to the second calendar, the at least one second time corresponding to at least one of the at least one first time;
determining, using the first input and the second input, a third time at which the item is to be delivered.
